(19) United States
(12) Patent Application Publication
(10) Pub. No.: US 2005/0157813 A1
(43) Pub. Date: Jul. 21, 2005

(54) Methods and apparatus for signal distortion correction

(76) Inventors: Mark Cope, Bath (GB); Peter Kenington, Chepstow (GB); Steven Anthony Meade, Bristol (GB)

Correspondence Address: MENDELSOHN AND ASSOCIATES, P.C., 1500 JOHN F. KENNEDY BLVD., SUTIE 405, PHILADELPHIA, PA, 19102, US

(21) Appl. No.: 10/480,761

(22) PCT Filed: Jun. 12, 2002
(86) PCT No.: PCT/GB02/02767

(30) Foreign Application Priority Data
Jun. 15, 2001 (GB) 0114803.0

(51) Int. Cl. H04K 1/02

(52) U.S. Cl. 375/297

(57) ABSTRACT

The digital predistorter multiplies the input signal with coefficients obtained from look-up tables. To reduce the amount of storage required, the coefficients are stored in partial form and are either reconstituted by addition of a constant (44, FIG. 3b) prior to application to the input signal or the retrieved coefficients are applied directly to the input signal and the resulting modified signal is then combined with the original input signal (34, FIG. 2a).

The invention relates to methods of, and apparatus for, correcting signal distortion by employing a group of adaption coefficients to adjust a consequential signal to ameliorate distortion in an output signal produced by signal handling equipment in response to an input signal. In particular, the distortion correction involved is the linearisation of the signal handling equipment.

The use of digital pre-distortion has significant flexibility benefits compared with conventional RF predistorters. In the case of a digital pre-distorter, a more sophisticated non-linearity may be formed without a significant increase in the required hardware complexity and all aspects of this non-linearity may be updated under automatic control. Additionally the accuracy of distortion measurement for adaptive control is normally much improved in a digital predistortion architecture compared to the RF pre-distorter architecture.

It is also beneficial to pre-distort for non-linear memory effects in a power amplifier. Memory effects result in the amplifier distortion characteristics being different at the same envelope level depending upon past history, for example following a large RF output pulse. Non-linear memory effects are a common observation in power amplifiers and manifest themselves as imbalanced distortion products around the wanted signal spectrum. Correction of memory effects becomes increasingly more important as the bandwidth of the wanted signal increases.

The performance of a digital pre-distortion linearisation system is limited largely by the resolution of the various parts of the digital system, for example:
1. The resolution of the data converters (A/D and D/A) used to sample the feedback signal or to supply the pre-distorted signal.
2. The size and resolution of the look-up tables.
3. The resolution of the signal processing (error estimation and adaption).
4. The resolution used in any input pre-processing or output post processing (e.g. digital up or downconversion, filtering).

The various resolutions used in each of these parts of the system need not be equal and indeed it is beneficial for them to differ from the standpoint of the optimum use of digital hardware resources, for example in an FPGA or ASIC implementation.

One object of the invention is to provide improved techniques for reducing the distortion of signals, for example techniques for performing predistortion linearisation.

According to one aspect, the invention provides apparatus for correcting signal distortion by employing a group of adaption coefficients to adjust a consequential signal to ameliorate distortion in an output signal produced by signal handling equipment in response to an input signal, the apparatus comprising means for using partial adaption coefficients in the adjustment of the consequential signal and means for correcting for the fact that the retrieved coefficients are partial to give the effect that adjustment of the consequential signal has been done using complete adaption coefficients.

The invention also consists in a method of correcting signal distortion by employing a group of adaption coefficients to adjust a consequential signal to ameliorate distortion in an output signal produced by signal handling equipment in response to an input signal, the method comprising using partial adaption coefficients in the adjustment of the consequential signal and correcting for the fact that the retrieved coefficients are partial to give the effect that adjustment of the consequential signal has been done using complete adaption coefficients.

Partial adaption coefficients can be smaller than complete adaption coefficients. This means that a partial adaption coefficient can be represented with fewer bits than a complete adaption coefficient. Thus, partial adaption coefficients may require less storage, and hence this leads to a reduction in power consumption. For a given resolution, fewer bits may be required to specify a partial adaption coefficient compared to its corresponding complete adaption coefficient because partial adaption coefficients can be smaller than complete adaption coefficients. Thus, where a given number of bits is available to represent an adaption coefficient, the use of the partial form allows a greater resolution to be used for the adaption coefficient.

In one embodiment, the correction for the use of partial adaption coefficients is to adjust the retrieved partial adaption coefficients so that they become their corresponding complete adaption coefficients. This can be implemented by making each partial adaption coefficient equal to its corresponding complete adaption coefficient less a constant. The constant can then be added to each partial adaption coefficient before it is applied to the consequential signal. In a preferred embodiment, at least a substantial proportion of the complete adaption coefficients lie near a particular value and that value is used as the constant.

In another embodiment, the partial adaption coefficients are applied to the consequential signal and the correction for the use of partial adaption coefficients is achieved by combining the adjusted (i.e. after treatment with the partial coefficients) and unadjusted (i.e. before treatment with the partial coefficients) versions of the consequential signal. Preferably, the unadjusted and adjusted versions of the consequential signal are time aligned before combination. The unadjusted and adjusted versions of the consequential signal may be scaled relative to one another before combination.

In one embodiment, the coefficients to be used are selected from the group by an indexing signal. Advantageously, the indexing signal can be adjusted to correct for memory effects in the signal handling equipment.

According to a second aspect, the invention provides apparatus for correcting signal distortion by employing a group of adaption coefficients to adjust a consequential signal to ameliorate distortion in an output signal produced by signal handling equipment in response to an input signal, the apparatus comprising means for selecting coefficients to use in the adjustment of the consequential signal using an indexing signal, and means for adjusting the indexing signal to correct for memory effects in the signal handling equipment.

The invention also consists in a method of correcting signal distortion by employing a group of adaption coefficients to adjust the consequential signal to ameliorate distortion in an output signal produced by signal handling equipment in response to an input signal, the method comprising selecting coefficients to use in the adjustment of the consequential signal using an indexing signal, and adjusting the indexing signal to correct for memory effects in the signal handling equipment.

The adjustment of the indexing signal may be achieved by subjecting it to a time-shift or to filtering.

In a preferred embodiment, the distortion correction is the linearisation of the signal handling equipment. Preferably, this linearisation is by way of predistortion, in which case the consequential signal is the input signal to the signal handling equipment. In another embodiment, the linearisation is by way of a feedforward arrangement, in which case the input signal to the signal handling equipment is sensed and the consequential signal is the sensed input signal which is combined with the output signal subsequent to adjustment using the adaption coefficients.

In preferred embodiments, the signal handling equipment is an amplifier or an arrangement of amplifiers.

By way of example only, certain embodiments of the invention will now be described with reference to the accompanying figures, in which:

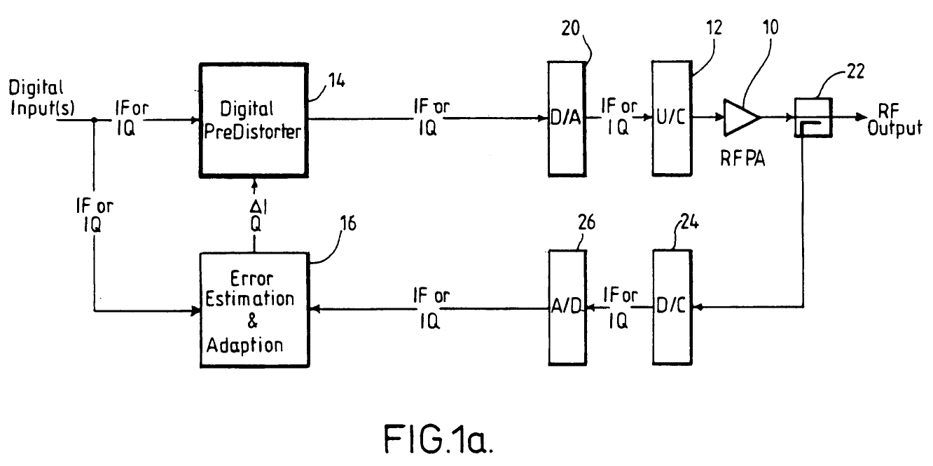

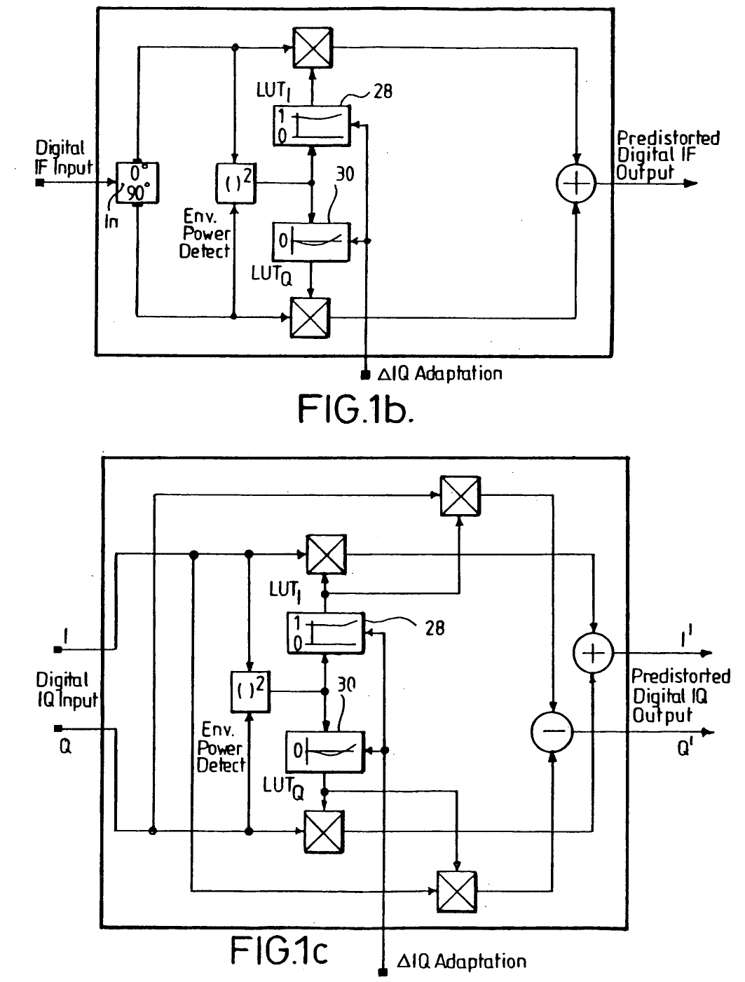

FIG. 1a is a block diagram of a conventional digital to RF transmitter with digital predistortion;

FIG. 1b illustrates the architecture of the predistorter block in FIG. 1a when the input signal is in digital IF (intermediate frequency) form;

FIG. 1c illustrates the architecture of the predistorter block in FIG. 1a when the input signal is in IQ format;

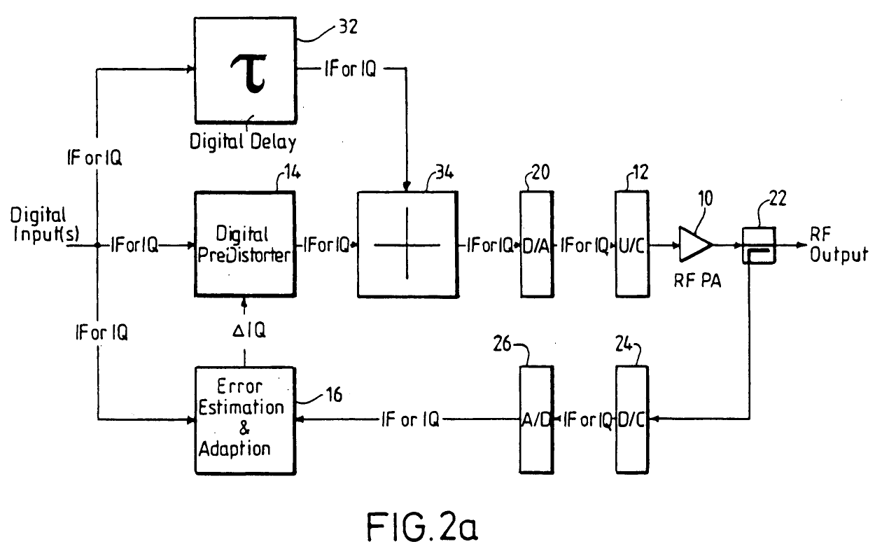

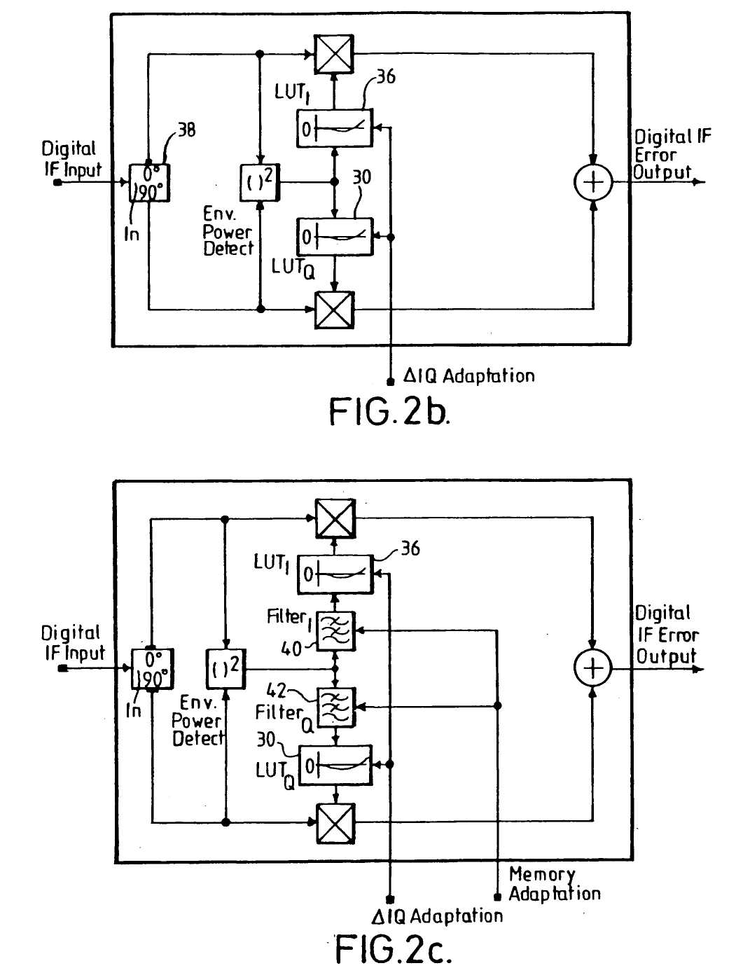

FIG. 2a is a block diagram of a digital to RF transmitter with digital predistortion according to the invention;

FIG. 2b illustrates the architecture of the predistorter block in FIG. 2a;

FIG. 2c illustrates an alternative form for the predistorter block in FIG. 2a;

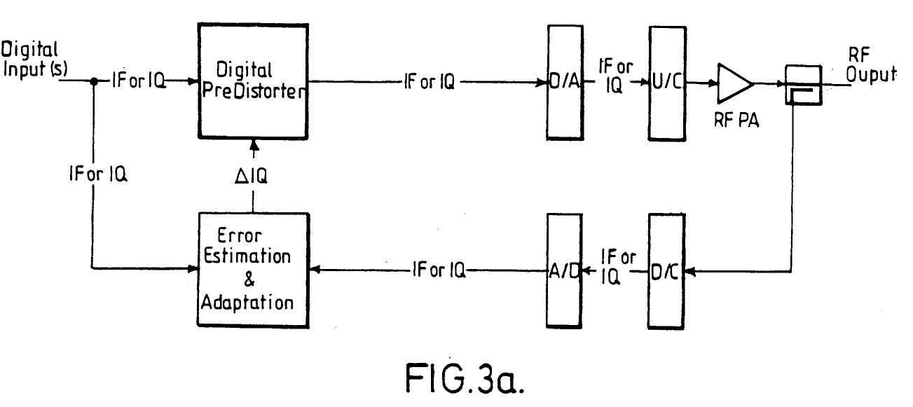

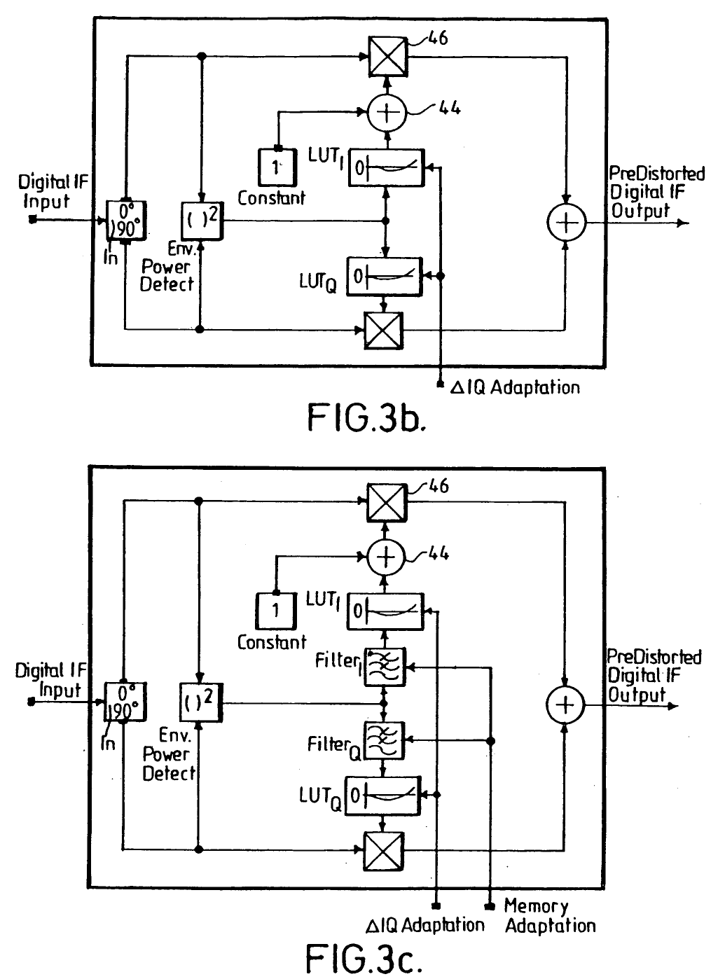

FIG. 3a is block diagram of a digital to RF transmitter with digital predistortion according to another embodiment of the invention;

FIG. 3b illustrates the architecture of the predistorter block in FIG. 3a; and

FIG. 3c illustrates an alternative form for the predistorter block in FIG. 3a.

A block diagram of a conventional digital to RF transmitter with digital predistortion is shown in FIG. 1a. In this system, a digital input is assumed, although an RF input could be accommodated by adding a downconversion function together with analog to digital conversion (A/D) to convert an RF input into a digital input.

The RF power amplifier (RFPA) 10, and the upconverter (U/C) 12 to a lesser extent, exhibit non-linear characteristics producing amplitude and phase distortion. The digital predistorter 14 overcomes these non-linearities by modifying the digital inputs to form a new digital data stream such that there is minimal difference between the two inputs at the error estimation and adaptation block 16. This modified data stream is converted to an analog signal by digital to analog convertion (D/A) at 20 and up-converted at 12 to the required RF frequency at low power. The power amplifier 10 then amplifies the low power RF signal producing the majority of the signal distortion. A sample of the output power is fed back from 22 to the error estimation block 16 via a downconverter (D/C) 24 and analog to digital conversion (A/D) at 26.

The architectures for the digital predistortion block 14 shown in FIGS. 1b and 1c show the input signal being processed in quadrature though it is also possible to process in amplitude and phase (polar coordinates) also. Either allows both amplitude and phase distortion characteristics to be linearised.

In the pre-distorter block architectures, the digital input samples are weighted (multiplied) by the values contained in the look-up tables 28, 30. The FIG. 1c architecture has the disadvantage of requiring more multipliers due to the IQ format of the input signal but has the advantages of possibly running at a lower clock frequency and more flexibility in the upconversion process 12. The appropriate lookup table (LUT) value for a given sample is selected from the table by means of a table index. This indexation is typically based on the input envelope power as shown here (at 27), although other possibilities exist (e.g. input envelope amplitude).

The inefficient use of digital hardware in this prior art is manifested in the “I look-up table” (LUT_{I}) 28 whose values are centred about unity. As the LUT is located in the main signal path, its resolution must account for both the linear and non-linear aspects of the desired response. For example, if a given sample required a 5% increase in gain in order to compensate for the amplifier non-linearity present at that power level, the look-up table would contain a value of 1.05000—multiplying this with the input sample would yield the desired gain expansion. However to avoid introducing noise resulting from the discrete number of levels in the LUT its depth must be deep, typically 12-14 bits in most digital communications applications. This requires a significant amount of digital hardware resource to store this information at this accuracy and also in the multiply and add steps that follow.

The embodiments that follow reduce the digital hardware requirement by only requiring the gain error part of the LUT to be stored (0.05000 in the example above instead of 1.05000) i.e. removing the linear part of the multiplication. This concentrates the digital system resolution where it is needed in accurately creating the gain compression/expansion required and reduces the number of bits in the LUT by 3-4 typically.

An additional advantage conferred by some of the following embodiments is that memory effects are to be predistorted; this is not possible in the FIG. 1 architecture where the linear and gain compression/expansion terms are combined in the one table.

The architecture of FIG. 2a which separates the linear gain part from the gain error part (compression/expansion) of the characteristic incorporates a digital delay 32 in parallel with the predistortion processing 14. This delay 32 has unity gain and serves to time-align the linear signal with the error signal at the summing junction 34. Since this processing occurs digitally, it is possible to ensure that this alignment occurs precisely, hence preserving the same linearisation bandwidth as that of the prior art.

As shown in FIG. 2b, the LUT_{I} 36 now merely contains the value of the gain expansion (or compression) required at a given power level (e.g. the 5% expansion mentioned above) and hence the full resolution of the system may be used to represent this (e.g. 5%) value reducing the number of bits used in the LUT_{I} by 3-4 typically. This is illustrated in FIG. 2b where the LUT_{I} table is shown centred around 0 instead of I as in FIG. 1b. Note that the predistorter architecture of FIG. 2b is also suitable for digital IQ input although it has not been illustrated here. Briefly, the predistorter architecture in FIG. 2b would need the input 90° splitter 38 taken out and two additional multipliers with subtractor added as illustrated in FIG. 1c. A similar conversion from digital IF to digital IQ format can be made for all of the following embodiments of the predistorter block architecture.

The operation of the remainder of the system of FIG. 2a is identical to that described with reference to FIG. 1a, with the exception that the error estimation and adaptation function is now only required to calculate the desired gain expansion or compression and not the overall transfer characteristic. It can therefore operate at the required (optimum) resolution.

The FIG. 2a architecture is also ideal for the inclusion of memory correction, which is particularly important for wide bandwidth systems. The predistorter block 14 can take the form shown in FIG. 2c to achieve this. The filters 40, 42 preceding the I and Q lookup tables typically have different characteristics to allow for different memory characteristics in the amplitude and phase distortion processes in the power amplifier (PA) 10. These filters delay the input envelope to the LUTs to match those processes taking place in the PA 10. They may also or additionally reshape the input envelope supplied to the LUTs.

The important feature of the FIG. 2a is the separation of the linear and error correction parts of the gain term that allows the error correction parts to be delayed and filtered relative to the linear part. This architecture is capable of predistorting for imbalances of the distortion products that are common in power amplifiers.

Filter_{I} 40 and Filter_{Q} 42 could also be placed immediately after their respective LUTs though the preferred embodiment is in the position shown.

An alternative architecture is shown in FIGS. 3a to 3b. This architecture accomplishes the requirement of separating the linear and error correcting parts of the gain without the delayed input signal path. Instead, the separation is achieved by adding at 44 a constant to the output of the LUT_{I} output before multiplication process 46. This alternative) architecture offers the same advantages over the prior art as those of FIG. 2 in being able to reduce the size of the LUT significantly and to allow for memory effect correction (FIG. 3b).

The differences between the architectures of FIGS. 2 and 3 lie in the small differences in size of the multipliers and adders.

The invention has been described above in the context of applying partial coefficients to a consequential signal to ameliorate distortion. Of course, it will be apparent to the skilled person that the invention also extends to using partial coefficients in some other kind of signal processing operation performed on a target signal, with a correction for the fact that the retrieved coefficients are partial to give the effect that the signal processing operation has been done using complete coefficients.

1-28. (canceled)

29. A method for applying adjustments to signal processing associated with signal handling equipment, the method comprising:
retrieving partial coefficients corresponding to portions of complete coefficients associated with the adjustments; and
applying the partial coefficients to generate the adjustments, wherein corrections are made for the use of the partial coefficients to give the effect that the adjustments have been generated by retrieving and applying complete coefficients.

30. The invention of claim 29, wherein:
the signal handling equipment comprises one or more amplifiers; and
the adjustments to the signal processing reduce distortion in an output signal produced by the one or more amplifiers.

31. The invention of claim 29, wherein the adjustments to the signal processing correspond to at least one of predistortion of an input signal prior to application to the signal handling equipment and feed-forward distortion correction of an output signal generated by the signal handling equipment.

32. The invention of claim 31, wherein the adjustments to the signal processing correspond to the predistortion of the input signal prior to application to the signal handling equipment.

33. The invention of claim 29, wherein:
the corrections correspond to a linear part of the adjustments; and
the partial coefficients correspond to deviations from the linear part.

34. The invention of 33, wherein:
the linear part corresponds to a coefficient value of one; and
the partial coefficients correspond to deviations of the complete coefficients from the coefficient value of one.

35. The invention of claim 29, wherein:
the partial coefficients are applied to a first digital part of an input signal to generate partial adjustments; and
the partial adjustments are combined with complementary adjustments, wherein the complementary adjustments correct for the use of the partial coefficients during the generation of the partial adjustments.

36. The invention of claim 35, wherein the first digital part of the input signal corresponds to an in-phase component I of the input signal.

37. The invention of claim 29, wherein each partial coefficient is combined with a complementary coefficient prior to being applied to a first digital part of an input signal.

38. The invention of claim 37, wherein the first digital part of the input signal corresponds to an in-phase component I of the input signal.

39. The invention of claim 29, wherein:
the partial coefficients are retrieved by applying indices to a lookup table; and
at least one of the indices and the partial coefficients are filtered prior to generating the adjustments.

40. The invention of claim 39, wherein the filtering applies memory characteristics to the adjustments to the signal processing.

41. The invention of claim 39, wherein the filtering is applied to the indices prior to retrieving the partial coefficients.

42. The invention of claim 29, wherein:
the partial coefficients correspond to partial adjustments of an in-phase component I of the input signal;
a second set of coefficients corresponding to adjustment of a quadrature-phase component Q of the input signal is retrieved by applying the indices to another lookup table;
a first filter is applied to at least one of the indices and the partial coefficients; and
a second filter is applied to at least one of the indices and the second set of coefficients, wherein the first and second filters apply different memory characteristics to the adjustments to the signal processing.

43. The invention of claim 42, wherein the first and second filters are independently applied to the indices prior to retrieving the partial coefficients and the second set of coefficients, respectively.

44. An apparatus for applying adjustments to signal processing associated with signal handling equipment, the apparatus comprising:
means for retrieving partial coefficients corresponding to portions of complete coefficients associated with the adjustments; and
means for applying the partial coefficients to generate the adjustments, wherein the applying means is adapted to make corrections for the use of the partial coefficients to give an effect that the adjustments have been generated by retrieving and applying the complete coefficients.

45. An apparatus for applying adjustments to signal processing associated with signal handling equipment, the apparatus comprising:
a first lookup table (LUT) adapted to store partial coefficients corresponding to portions of complete coefficients associated with the adjustments; and
adjustment circuitry adapted to apply the partial coefficients to generate the adjustments, wherein the adjustment circuitry is adapted to make corrections for the use of the partial coefficients to give an effect that the adjustments have been generated by retrieving and applying the complete coefficients.

46. The invention of claim 45, wherein:
the signal handling equipment comprises one or more amplifiers; and
the adjustment circuitry is adapted to reduce distortion in an output signal produced by the one or more amplifiers.

47. The invention of claim 45, wherein the adjustments to the signal processing correspond to at least one of predistortion of an input signal prior to application to the signal handling equipment and feed-forward distortion correction of an output signal generated by the signal handling equipment.

48. The invention of claim 47, wherein the adjustments to the signal processing correspond to the predistortion of the input signal prior to application to the signal handling equipment.

49. The invention of claim 45, wherein:
the corrections correspond to a linear part of the adjustments; and
the partial coefficients correspond to deviations from the linear part.

50. The invention of 49, wherein:
the linear part corresponds to a coefficient value of one; and
the partial coefficients correspond to deviations of the complete coefficients from the coefficient value of one.

51. The invention of claim 45, wherein the adjustment circuitry comprises:
a first multiplier adapted to apply the partial coefficients retrieved from the first LUT to a first digital part of an input signal to generate partial adjustment components; and
one or more combiners (34) adapted to combine a signal corresponding to the partial adjustment components with the input signal to generate the adjustments.

52. The invention of claim 51, wherein the adjustment circuitry further comprises:
a second LUT adapted to store a second set of coefficients associated with the adjustments; and
a second multiplier adapted to apply the second set of coefficients retrieved from the second LUT to a second digital part of the input signal to generate second adjustment components, wherein:
the one or more combiners are adapted to combine the partial adjustment components, the second adjustment components, and the input signal to generate the adjustments.

53. The invention of claim 52, wherein:
the first LUT is adapted to store partial I coefficients; and
the second LUT is adapted to store Q coefficients.

54. The invention of claim 53, wherein:
the partial I coefficients and the Q coefficients are retrieved from the first and second LUTs based on indices; and
the adjustment circuitry further comprises:
a first filter adapted to filter at least one of the indices and the partial I coefficients; and
a second filter adapted to filter at least one of the indices and the Q coefficients, wherein the first and second filters are adapted to apply different memory characteristics to the adjustments.

55. The invention of claim 54, wherein the first and second filters are independently applied to the indices prior to retrieving the partial I coefficients and the Q coefficients, respectively.

56. The invention of claim 45, wherein the adjustment circuitry comprises:
a first combiner adapted to combine the partial coefficients retrieved from the first LUT with a constant to generate the complete coefficients; and
a first multiplier adapted to apply the complete coefficients to a first part of an input signal to generate first adjustment components for the adjustments.

57. The invention of claim 56, wherein the adjustment circuitry further comprises:
a second LUT adapted to store a second set of coefficients associated with the adjustments;
a second multiplier adapted to apply the second set of coefficients retrieved from the second LUT to a second digital part of the input signal to generate second adjustment components for the adjustments; and
a second combiner adapted to combine the first and second adjustment components to generate the adjustments.

58. The invention of claim 57, wherein:
the first lookup table is adapted to store partial I coefficients; and
the second lookup table is adapted to store Q coefficients.

59. The invention of claim 58, wherein:
the partial I coefficients and the Q coefficients are retrieved from the first and second LUTs based on indices; and
the adjustment circuitry further comprises:
a first filter adapted to filter at least one of the indices and the partial I coefficients; and
a second filter adapted to filter at least one of the indices and the Q coefficients, wherein the first and second filters are adapted to apply different memory characteristics to the adjustments.

60. The invention of claim 59, wherein the first and second filters are independently applied to the indices prior to retrieving the partial I coefficients and the Q coefficients, respectively.

61. The invention of claim 45, wherein:
the partial coefficients are retrieved from the first LUT based on indices; and
the adjustment circuitry further comprises a filter adapted to filter at least one of the indices and the partial coefficients.

62. The invention of claim 61, wherein the filter is adapted to apply memory characteristics to the adjustments.

63. The invention of claim 61, wherein the filter is applied to the indices prior to retrieving the partial coefficients.
